(19) United States
(12) Patent Application Publication
(10) Pub. No.: US 2009/0222235 A1
(43) Pub. Date: Sep. 3, 2009

(54) DEVICE FOR MONITORING A PRODUCT DEGRADATION

(75) Inventor: Renaud Vaillant, Gentilly (FR)

Correspondence Address: RATNERPRESTIA, P.O. BOX 980, VALLEY FORGE, PA, 19482, US

(73) Assignee: CRYOLOG S.A., Gentilly (FR)

(21) Appl. No.: 12/159,431

(22) PCT Filed: Dec. 28, 2006
(86) PCT No.: PCT/FR2006/002909

§ 371 Date: Oct. 20, 2008

Related U.S. Application Data
(60) Provisional application No. 60/754,413, filed on Dec. 28, 2005.

(51) Int. Cl. G01K 3/04; G06F 15/00

(52) U.S. Cl. 702/130; 374/102; 374/E03.004

(57) ABSTRACT

The invention relates to device (10) for monitoring the degradation of a perishable product, this device being designed to be placed in the proximity of the product, this device comprising:
A time measuring module (12), such as a clock, and at least one sensor (14) measuring at least one extrinsic variable of the product representing the preservation conditions of this product, such as the temperature, the relative humidity, the atmospheric composition.
a programme memory (16) for memorising a programme representing a specific degradation model of a monitored product,
a processor (18), using the programme representing the degradation model to calculate the condition of degradation of the product according to the time and values of the extrinsic variables measured by the sensor.
a data memory (20) for storing the intrinsic parameters of the product, the intrinsic parameters of the product being its pH and/or its texture, and/or its activity in water, and/or the quantity of organic acid it contains, and/or its heat transfer coefficient, and/or the limiting flora it contains, and/or the enzyme degradation products, and/or the redox potential,
changes in the intrinsic parameters being taken into account in the degradation model, so that the degradation calculation carried out by the processor is only based on the extrinsic variables and time.

The present invention relates to a device for monitoring the degradation of a product, in particular perishable products such as foods.

In the agro-food industry, and more particularly in the domain of fresh and frozen produce, monitoring compliance with the cold chain is essential to food safety. For a long time, manufacturers have been required by law to display a use-by date on the packaging of many products. Determining these dates is the responsibility of manufacturers with more or less important technical margins for taking into account the differences in preservation conditions according to the various routings of the product from manufacture to the site of consumption. Use-by dates are thus determined depending on theoretical conditions of preservation of products and do not therefore take into account the real state of degradation of each product.

Because of this, the information on the condition of the product supplied by the use-by date is almost always wrong. In effect, if the actual conditions of preservation were optimal, the product will be in a fit state for consumption even after the use-by date has expired. Conversely, if the actual conditions were worse than the theoretical conditions used for determining the use-by date, then the product will no longer be in a fit state for consumption even though the use-by date has not yet been reached.

It is therefore of interest to manufacturers as well as consumers to be able to take into account the real state of degradation of each product. Risks are therefore eliminated for the manufacturer as well as for the consumer. In effect, for the manufacturers, knowing the real state of degradation of a product simplifies the logistic management of routed products, in particular the transfer of responsibility between the manufacturer and their distributor.

For the consumer, all health risks are avoided that are due to the consumption of a product unsuitable because of preservation conditions inferior to those used for determining the use-by date of the products concerned

For knowing the precise state of degradation of a fresh product, one method consists of measuring the temperature and the time to be able to obtain the historical record of temperature variations over time. It is imperative that these two parameters are monitored because, if the cold chain is broken between manufacture and consumption, it must be possible to assess the level by which the maximum temperature has been exceeded, as well as the length of time of this rupture. Knowing this historical record, makes it is therefore possible to determine, according to each product, using calculation models produced from microbiological predictions, whether the product is in a fit state for consumption or not.

However, while it is simple to know the historical record of the temperature of a storehouse, monitoring required for individual products, or for a group of identical products being packaged together (for example on a palette), is technically more difficult, particularly because the inclusion of an individual monitoring device should represent a very low cost increment in relation to the monitored product. In the International application WO2005/106813 a compact monitoring device is known, in the form of an “RFID label” designed to be fixed onto the packaging of a perishable product, making it possible to track the historical temperature record over time. Such a device is equipped with a calculation function, which permits the sending of information relating to the condition of freshness of the monitored product based on the historical temperature record.

The device described in the above mentioned patent proposes the use of calculation methods based on the Arrhenius model which cannot be finely adapted to each product and, what is more, requires an important degree of calculation.

Whereas, in an effort to minimise the energy required by such a device as well as its cost, it is advantageous to use a method of calculation permitting the best compromise between the pertinence of the obtained result and the degree of calculation required.

Thus, the invention relates to a device for monitoring the degradation of a perishable product, this device being designed to be placed in the proximity of the product, this device comprising:
A time measuring module, such as a clock, and at least one sensor measuring at least one extrinsic variable of the product representing the preservation conditions of this product, such as the temperature, the relative humidity, the atmospheric composition,
a programme memory for memorising a programme representing a specific degradation model of the monitored product,
a processor, using the programme representing the degradation model to calculate the state of degradation of the product according to the time and values of the extrinsic variables measured by the sensor.
a data memory for storing the intrinsic parameters of the product, the intrinsic parameters of the product being its pH and/or its texture, and/or its activity in water, and/or the quantity of organic acid it contains, and/or its heat transfer coefficient, and/or the limiting flora it contains, and/or the enzymatic degradation products, and/or the redox potential,
evolution of the intrinsic parameters being taken into account in the degradation model, so that the degradation calculation carried out by the processor is only based on the extrinsic variables and time.

Thus, fine tuned monitoring is carried out since it is completely adapted to the product because the various intrinsic parameters are taken into account, whilst using a model which applies simple calculations and therefore requires a relatively low degree of calculation.

In one embodiment, the programme memory can memorise one or several additional programmes.

In one embodiment, the memory programme memorises a measurement management programme.

In one embodiment, the measurement management programme determines the frequency of measurements of the extrinsic variable.

In one embodiment, if, between two measurements, the variation in the extrinsic variable is lower than a predetermined threshold, the measurement management programme determines a lower measurement frequency and/or orders the processor not to carry out a new calculation of the condition of degradation.

In one embodiment, the device comprises means of communication which are of radio type.

In one embodiment, the device supplies, in response to a question of an adapted reader, a signal representing information relative to the state of degradation of the product.

In one embodiment, the information supplied also comprises: a product identifier, and/or a measured use-by date, and/or the difference between the measured use-by date and the theoretical use-by date.

In one embodiment, the information supplied comprises the historical record of variations in the extrinsic variable from the start of the product's monitoring.

In one embodiment, the device comprises a rechargeable battery for powering the processor (18) and/or the programme memory (16) and/or the data memory (20).

In one embodiment, the battery can be recharged during the use of the device (10).

In one embodiment, the device is reusable after consumption or degradation of the monitored product.

A detailed example of an embodiment of the invention is described here-below, in relation to the figures, amongst which:

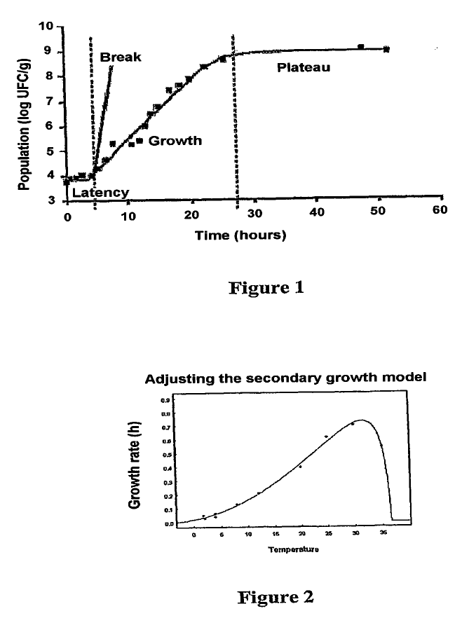

FIG. 1 represents a primary model of the growth of a microorganism;

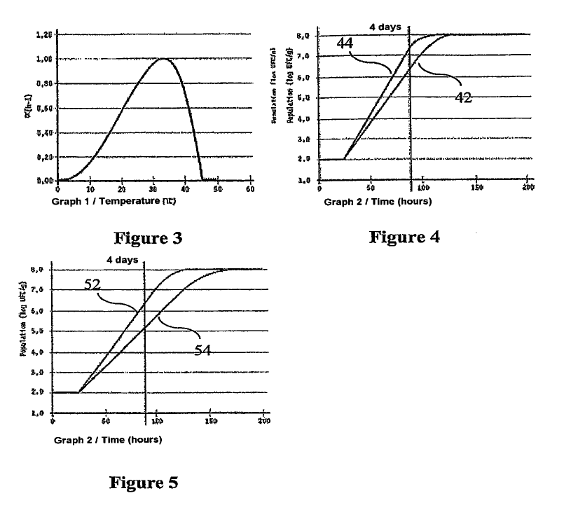

FIGS. 2 and 3 represent a cardinal model according to temperature;

FIGS. 4 and 5 represent different changes in the population of a microorganism modelized according to the cardinal model in FIG. 3;

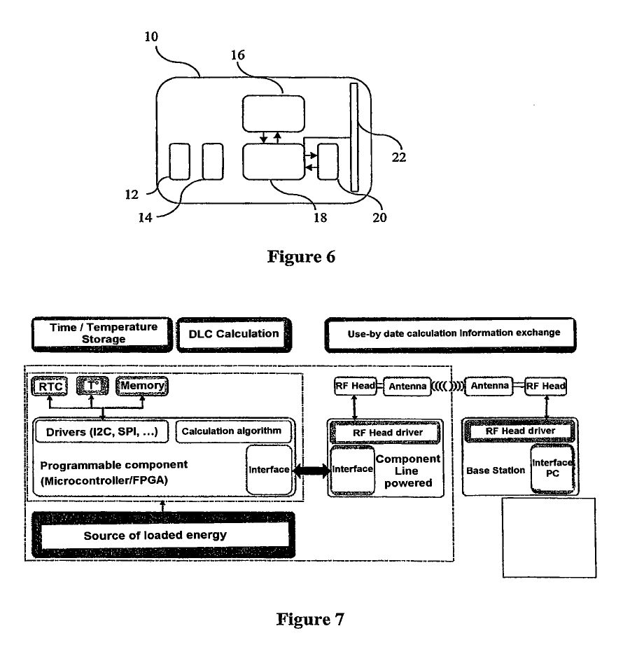

FIG. 6 represents a device according to the invention;

FIG. 7 represents the internal architecture of the device according to the invention;

The state of degradation of a perishable product, in particular food products is principally linked to the presence and the development of microorganisms, whether they are pathogenic or spoiling. To know the state of degradation of a food product, all that is required is to determine which is/are the limiting flora/s, that is to say the microorganism(s), wherein quantity and/or growth could be predominantly active in the degradation of the product, from the group of microorganisms contained in the product. Once the microorganisms having predominant influence have been identified, all that is required is to know their respective quantities in order to deduce the state of degradation.

Thus, for each type of microorganism a maximum threshold is fixed over which the product is considered to be no longer fit for consumption. The prediction of degradation of a product therefore consists of modelizing the population development of each limiting flora contained in the product.

A first approach to this modelizing, represented in FIG. 1, is a primary type model which makes it possible to determine the growth of a bacterium at constant temperature, pH and water activity. FIG. 1 shows the population development of the bacterium according to time. This development is represented in one part by the curve 10 obtained using the model, and, in another part by the sporadic values obtained experimentally

The model used in this case is represented by the following equation:

$$If t \leq at lag \frac{d N}{d t} = 0$$

$$If t > at lag \frac{d N}{d t} = {μ}_{max} N \cdot ( 1 - \frac{N}{{N}_{max}} )$$

In which:
N=number of cells
Nₘₐₓ=maximum number of cells
μ=maximum rate of specific growth

The advantage of this model is that it makes it possible to visualise the 3 successive phases of microbial development: latency phase (time span), growth phase (following a break), stationary phase (plateau). It cannot however constitute a useful estimation model since it only takes one factor into account which is time.

To describe a growth linked to more than two factors, models are used which are known as secondary models. Said models make it possible to precisely evaluate the degradation of a product by describing the evolution of parameters of primary models (latency times, maximal growth rate, maximum cellular concentration), in relation to environmental conditions, represented by the intrinsic parameters defined hereabove.

Of these secondary models, the difference is made between polynomial and cardinal models.

In the case of a polynomial model, growth is defined by an equation in the following form:

Growth=ax+by+cz+dx²+ey²+ . . . +fzⁿ, where x, y, . . . z are environmental factors. Polynomial models provide acceptable predictions in the domain where they have been established.

Cardinal models are based on the cardinal values of the parameters which influence the growth of the microorganisms in question, in particular the cardinal values of temperatures (Tₘᵢₙ, Tₒₚₜ, Tₘₐₓ), of pH (pHₘᵢₙ, pHₒₚₜ, pHₘₐₓ), of water activity (aw), etc.

for example the “CTMI” model, represented in FIG. 2, (Cardinal Temperatures Model with Inflexion Point) expresses the growth rate according to the temperature:

μₘₐₓ=maximum growth rate

μₒₚₜ=growth rate in optimum conditions, that is to say in the maximum favourable conditions of growth for microorganisms.
Tₘᵢₙ=base temperature limit at which growth can be seen. Below this temperature, growth is nil.
Tₘₐₓ=top temperature limit at which growth can be seen. Above this temperature, growth is nil.
Tₒₚₜ=temperature at which growth is maximum. In these models, the cardinal values of temperature, of pH, . . . etc. are specific to a species of microorganism, or of a strain.

These models give good adjustment precision, for calculations which are relatively simple. They also present the advantage of an obvious biological significance of the parameters (temperatures, pH, aw . . . ). Finally, they are evolutionary models, therefore presenting wide-ranging possibilities for the improvement of predictions.

An example is described here-below illustrating the impact of cardinal values on growth simulations. It concerns the prediction of a Listeria growth, wherein cardinal temperatures are 45° C., 1° C. and 33° C. FIG. 3 shows the calculation of growth rates predicted by the model according to temperatures, and FIG. 4 shows the evolution of the microbial population obtained at a temperature of respectively 10° C. for curve 42, and 12° C. for curve 44, over a period of 200 hours. FIG. 5 also shows the evolution of the microbial population obtained at a temperature of respectively 10° C. for curve 52, and 8° C. for curve 54. Here we obtain the following values:

Tₘᵢₙ=base temperature limit at which growth can be seen; in the example, Tₘᵢₙ=1° C.

Tₘₐₓ=top temperature limit at which growth can be seen; Tₘₐₓ=45° C.

Tₒₚₜ=temperature at which growth is maximum; Tₒₚₜ=33° C.

By modifying the preservation temperature by more or less 2° C., estimation of growth at 4 days is reduced (curve 44, FIG. 4) or increased (curve 54, FIG. 5) by a power of 10 (1 log).

As previously described, the first calculations use primary models: estimation of the growth rate and latency time (model proposed by ROSSO). Secondary models make it possible to subsequently integrate environmental effects on the parameters of primary models. Secondary models are polynomial or modular models; polynomial models are not very extrapolatable and, concerning foods, modular models are more often used. The effects taken into account by these models are:

temperature,

pH and organic acids,

water activity,

inhibitors.

Each of these factors is described by a function, to which an interactive function is added between these factors. Moreover, the characteristics of the food are taken into account by the optimal microorganism growth rate in the food (challenge tests are carried out for this). Finally, the growth rate of a microorganism in a food is dependant on 5 factors and on its optimal growth rate in this food:

μₘₐₓ=μₒₚₜ·γ_{T}·γ_{pH}·γ_{aw}·γ_{AH}·γᵢₙₜ

Therefore, predicting the development of a microorganism in a food necessitates knowledge of:

the particular characteristic parameters of the microorganism's growth: cardinal temperatures, pH and a_{w}, and MIC of inhibitors or organic acids;

the characteristics of the food/microorganism pair: optimum rate of growth, minimum latency time and maximum population;

the environmental factors of the microorganism in the food, three intrinsic factors (pH, aw and organic acid) and a single extrinsic factor: the temperature.

For the use in the device according to the invention of the calculations herein, it is not necessary to include the whole database in the chip but only a limited amount of data, which makes it possible to reduce the degree of calculations required. To simplify the calculation, it is possible to not include confidence intervals, for example by systematically using the least favourable case. The calculation can be incremented (and not redone) as temperatures are taken.

Cardinal models make it possible to take into account as many extrinsic variables as are desired. The principal extrinsic variables having an influence on the growth of microorganisms comprising:
the preservation temperature
the relative humidity
the atmospheric pressure
the atmospheric composition, that is to say the relative O₂, CO₂, N₂, NH₃ and ethylene content

Amongst the intrinsic parameters for which evolution is taken into account, it is possible to cite:
pH
water activity or aw
the texture of the food which intervenes at several levels diffusion, aw, heat transfer)
Quantity of organic acids
Redox potential
Enzymatic degradation products: they can correspond with degradation products relating to hydrolysis/proteolysis and aminopeptidasic activities, which lead to the formation of volatile basis (of which biogenic amines) and ultimately the formation of NH3. It can also be the oxidation of fat, or lipasic and lipolytic activities. More generally, it is also possible to add concentration substrates/metabolites and waste
Physiological state of the strain in question (stationary phase, latency phase, . . . )
Initial microbial concentration
Interactions and products of interaction within and between microbial species
Temperature gradient within the product.

An analysis of the system architecture has been done, taking into account the cycle of use of the product, the function of services and constraints.

FIG. 6 represents a scheme of the device 10 according to the invention, in one embodiment adapted to the monitoring of fresh or frozen food products. The device 10 is in the form of a card or chip, comprising a clock 12, a temperature sensor 14. A processor 18 makes it possible to calculate the state of degradation of the monitored product, through a degradation model contained in a programme memory 16. This degradation model takes into account intrinsic parameters of the product and of their evolution, their values being stored in a data memory 20. Such a device is intended to be read remotely by a reading device, via a communications protocol by radio frequency. To this end the device includes an RFID antenna.

FIG. 7 shows the detailed architecture of the device according to the invention.

This particularly includes a source of energy for powering components of the chip.

A study has been carried out concerning the demonstrator's choice of components for the demonstration.

On the reader side, the demonstration will be based on an RFID reader 15693.

On the chip side, a RTC module+temperature sensor, reference DS1629 “digital thermometer and real time clock” was chosen.

For the demonstration, a memory I²C512K is used for data storage.

A low consumption microcontroller was chosen, operating the calculation of the use-by date, real time clock management and the temperature sensor. Concerning the RFID interface, 2 solutions are possible: The first is the use of an RF head developed at Leti, and a programmable line powerable component to support the protocol

Base Station

T° Memory

Programmable component

(Microcontroller/FPGA)

RF Head

Component

Line powered

RTC

Drivers (I2C, SPI, . . . ) Calculation algorithm

Interface Interface

RF Head driver

Storage

Time/Temperature

Use-by date calculation information exchange

RF Head

Interface

PC

RF Head driver

Antenna

Source of loaded energy

Antenna

RFID15693. The second solution consists of looking for a trade component.

The role of the RF head is to retrieve commands from the reader and transmit them to the micro, which will be responsible for carrying them out and sending a reply to the reader via the RF head.

The RF exchange will follow the 15693 standard

The protocol is based on a request by the reader to the chip, and a reply from the chip(s).

Data transmitted between the RF head and the microcontroller can be initialisation/parameter data for the correct functioning of the device, as well as information relating to the temperature tracking of the product.

Parameter data which can be used are described hereafter:
Coefficients for the heat transfer model implanted in the chip. The heat transfer model corresponds with the inertia of temperature change of a product according to parameters such as the food itself, the nature of its packaging, the safety margin required by the client etc. The parameters of this heat transfer model must be responsible for activating the chip.
The strain cardinal values: coefficients of the equation for predicting the microbiological development. These values depend on the nature of the product.
The personalisation of the chip, is very similar to a typical traceability use: loading of lot number, product number and the theoretical use-by date.
The triggering parameters for writing the time/temperature pair to the memory. In effect, not all of the measured values need to be written to the memory. That can depend on the chosen temperature delta for memorising between two measures. Storing two identical successive values is not necessary in order to limit the size of the memory.
Choice of a sampling model, which is going to vary the time between two measures according to the previous sampling model, the frequency should accelerate towards critical temperatures. (Data parameters can be set throughout the life of the product)
Initialising the activation time of the chip.
A sensor calibration may be necessary.

Data returned by the chip include:
Chip identification.
The measured use-by date, or length of remaining product life.
The theoretical use-by date.
The condition of the tracked product, according to the gap acceptance parameter (gap between the theoretical use-by date/measured use-by date).
Reading of memory data (time/temperature pair).

A first card has been created, comprising 1 microcontroller, 1 temperature sensor, 1 real time clock (RTC), 1 EEPROM memory and an RS232 link.

In a first instance, all driver commands of the card (loading parameters, start, stop, RTC programming etc.) are done through a serial link. A second card is being evaluated which includes an RFID ISO15693 interface.

The card operations are:
Calculation of real time temperature measurements,
Memorising the measured temperature value only if the temperature is different to the previous sample.

Test conditions: frequency of measurements scheduled every 5 seconds.

The temperature tracking is acquired in real time on the food product. Using microbiological prediction models, and the physiological characteristics of the main species of spoiling bacteria, it is possible to simulate the speed of microorganism development, and to deduce the remaining freshness content. The time remaining before the use-by date of the product is therefore re-estimated in real time, according to the temperature to which the food is subject during its preservation.

Mathematical models have been simplified to the maximum in order to reduce computer processing time. Calculations of remaining freshness content must be updated at regular intervals. To define this interval time, tests were carried out on actual temperature recordings.

A comparative study was thus carried out to measure the impact of interval time between two information processing operations (measure of tracked temperature followed by a re-estimation of freshness content). The shorter the interval time the more reliable the overall calculation. The percentage error of the different times tested are given below, compared to the reference interval of 5 minutes.

Time Interval Tested % Error

5 min: 0%

30 min: 0.8%

1 h: 1.9%

2 h: 3%

4 h: 4.8%

4 h shifted to 2 h: 7.7%

Two principal applications are hereby envisaged: Pharmaceutical and the agro-food industry. A cycle of use of the monitoring device according to the invention is described below. Before use, it is necessary to set a system recharge function by activating the battery. According to the level of monitoring required, the chip can either be placed on a palette of identical products, or on an intermediate package of such a palette, or again on each individual product, it being obvious that monitoring will be the most effective in this last case.

However, an interesting compromise consists of placing the chip on an intermediate package because said package would normally only contain a single product lot having the same use-by date. The question therefore arises of knowing if the temperature is homogenous at the centre of the intermediate package. The temperature read by the chip is on the outside of the package: the heat exchange coefficient should therefore be taken into account between the outside and the inside, including the possible differences depending on the environment. This heat transfer model should also take into account the nature of the intermediate package (cardboard, plastic crate, polystyrene): this data should be mentioned during activation. It is also possible to take into account the emplacement of the intermediary package on the palette.

Once the chip is in place, the first operation is to trigger the battery charging. Verification of charge can be done through a display on the charger according to a binary mode (charged/empty).

During the activation of the chip following battery charging, several data are necessary to the personalisation of the chip:

identification of product to be tracked (lot number, type),

Microbiological parameters of the model (cardinal values of the strain, information on heat transfers, specific product data of type pH/Aw/μₒₚₜ),

initial registration date (absolute date provided by the system) at sampling frequency.

calibration to be defined after n cycles.

Mathematical models permitting the calculation of degradation can be integrated during the design of the chip or during its activation. They comprise:

the microbiological prediction model determining the use-by date of the product,

the temperature management model permitting the acceleration or slowing down of sampling frequency depending on the temperature (parameters must therefore be set on the model in order that alarms are activated should the system be outside of required temperatures).

All data recorded at the moment of activation are important. For reasons of confidentiality or to mitigate bad handling by members of the chain, it is necessary to manage the rights of access to this information. The memory can thus be protected after information has been entered. If an instance of bad handling necessitates the amendment of recorded information, the only possibility of resetting initial data will be through the same operation as that of recycling the chip with total erasure of data followed by new registration. In order to facilitate handling, the writing function during use of the chip should therefore be autonomously managed by the chip.

Where the monitoring device according to the invention must be affixed to an intermediate package of products in the middle of a palette, said device can be in the shape of a credit card presenting a degree of rigidity. This can be placed on the inside of the package if the latter does not present an electromagnetic obstacle, but fixation on the outside is preferable for facilitating handling. The device should be firmly fixed with a simple system permitting its recuperation for recycling. For example, the device can be slid, inside a transparent self-adhesive envelope (of window type) and will be put in a new envelope after recycling.

The sampling frequency must be changed when moving on to another link in the logistic chain. This parameter must be able to be depicted on the chip by the various parties involved.

Access to data contained in the chip must be checked. Data can be read by all users, but once activation has occurred, there is no possibility for external writing: only the chip uses the writing function for storing temperatures.

The life span of the chip should be defined in accordance with the use-by date of products to be tracked. In the agro-food industry, the use-by date of fresh products can vary from several hours to 42 days, or even 60 days. Whereas, because the chip can be placed on the intermediate package, the average life span therefore corresponds with the length of a logistic period for this type of packaging, or 20 days. In the health sector, the life span of products can be as long as 2 years: chip energy management can be problematic, other than if battery charging can be done during storage by an antenna.

Reading data contained in the chip can be done by using a hand-held reading gun or through passage through a framed opening. The first solution is less practical in the case of reading a large number of chips. The second solution requires that storage zone platforms are fitted out so that the palettes can pass through framed openings when entering and leaving. Furthermore, reading the chips should be done parallel to the framed opening; in order to avoid the need to turn the palettes around to read the chips placed perpendicularly to the framed opening, 3D reading antennas should be used.

Data reading should provide information on:
the identifier,
the state of tracked products using simple language (“all is well” or “problem”) by comparison between the theoretical use-by date and the measured date,
the measured use-by date.

The condition of tracked products which are marked as “problem” should be adjusted by the client who defines the acceptable margin between the theoretical use-by date and the actual tolerated use-by date. Furthermore, if the client needs further information, then the complete reading can be done manually.

The calculation of the measured use-by date can be done:
in concurrent time whilst reading the identifier and the theoretical use-by date,
in real time at each writing of temperature to the chip and not at each measurement.

In effect, in order to economise on battery use, not all measurements defined by the internal clock are written in the chip. Writing can be started once there is a significant change in temperature, for example one of more or less 0.5° C.

Because of implementation costs, results could be displayed only on devices destined for the pharmaceutical sector. Data could be read directly or through a colour code describing the states of “all is well” or “problem” (this colour change could be displayed for example at the level of a polymer antenna). A recharge through inductive coupling (or other energies: solar) could be triggered during reading.

The end of the cycle of use is the last link in the logistic chain (the shop) which is responsible for recycling the chip. This latter member will have the role of stopping data recording and returning the chip to the chip supplier. This supplier must therefore retrieve the data and place them on a server which is accessible by the various members of the chain. The supplier will subsequently return the chip to zero and resend it to members of the chain.

The maximum life-span of the chip depends on its life-span on the product and the number of returns to the supplier. It can be estimated at 2 years: average life-span on the product of 20 days with 20 to 30 recycling cycles.

The device according to the invention presents the following advantages:

STANDARD: the device communicates with its environment by radio, via the RFID standard

PORTABILITY: the device can adapt to various packaging being used in the logistic circuit. Applied to the logistic units for tracking, and not to the product environment, it carries out constant monitoring over the whole chain.

REAL TIME: Portability, the standard of communication used and the precision of analysis permits the invention to transmit information on the preservation condition of the product in real time.

1. A device for monitoring the degradation of a perishable product, this device being designed to be placed in the proximity of the product, this device comprising:
a time measuring module, and at least one sensor measuring at least one extrinsic variable of the product representing the preservation conditions of the product.
a programme memory for memorising a programme representing a specific degradation model of the product,
a processor, using the programme representing the degradation model to calculate athe condition of degradation of the product according to the time and values of the extrinsic variables measured by the sensor,
a data memory for storing intrinsic parameters of the product, the intrinsic parameters of the product including at least one of pH or its texture, or its activity in water, or a quantity of organic acid it contains, or its heat transfer coefficient, or any limiting flora it contains, or any enzyme degradation products, or a redox potential,
wherein changes in the intrinsic parameters are taken into account in the degradation model, so that the degradation calculation carried out by the processor is based on the extrinsic variables and time, and
wherein values of the at least one extrinsic variable successively measured are stored, unless a difference between the measured value and a previously stored value is lower than a predetermined threshold.

2. A device according to claim 1, in which the programme memory memorises one or several additional programmes.

3. A device according to claim 2, in which the programme memory memorises a measurement management programme.

4. A device according to claim 3, in which the measurement management programme determines a measurement frequency of the at least one extrinsic variable.

5. A device according to claim 4, in which, if, between two measurements, the difference in the at least one extrinsic variable is lower than a predetermined threshold, the measurement managing programme determines a lower measurement frequency and/or orders the processor not to carry out a new calculation of the condition of degradation.

6. A device according to one of claims 1 to 5, comprising means of communication which are of radio type.

7. A device according to claim 6, further including an output channel for supplying, in response to a question of an adapted reader, a signal representing information relative to a state of degradation of the product.

8. A device according to claim 7, in which information supplied also comprises: at least one of a product identifier, or a measured use-by date, or a difference between the measured use-by date and a theoretical use-by date.

9. A device according to claim 7, in which the information supplied comprises a historical record of variations in the extrinsic variable from athe start of the product's monitoring.

10. A device according to one of claims 1 to 5, comprising a rechargeable battery for powering at least one of the processor or the programme memory or the data memory.

11. A device according to claim 10, in which the battery is configured to be recharged during the use of the device.

12. A device according to one of claims 1 to 5, in which the device is reusable after consumption or degradation of the monitored product.

13. A device according to one of claims 1 to 5, wherein the programmed processor includes means for checking access to data in the data memory.

14. A device according to one of claims 1 to 5 further comprising a memory for recording data relative to personalization of the device during the activation of said device.

15. A device according to claim 14, in which, after activation, the data memory is prevented from writing originating from outside, and the processor, using the writing function, is permitted to store measurements of the extrinsic variable.

16. A device according to one of claims 1 to 5, in which the calculation being done by the processor takes into account a heat exchange coefficient between an outside and an inside of the packaging of the product or of an intermediate packaging.
